(19) United States
(12) Patent Application Publication
(10) Pub. No.: US 2009/0064223 A1
(43) Pub. Date: Mar. 5, 2009

(54) DTV VIEWING TERMINAL, EPG SERVICE SYSTEM AND METHOD FOR EXHIBITING EPG

(75) Inventors: Chi Chia Lin, Tainan County (TW); Ching Kwei Hsu, Tainan County (TW); Chun Sung Chou, Tainan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, Tainan County (TW)

(21) Appl. No.: 11/845,417

(22) Filed: Aug. 27, 2007

(51) Int. Cl. G06F 3/00

(52) U.S. Cl. 725/39

(57) ABSTRACT

The method for accessing an EPG server includes the steps of: sending a web request from a browser-embedded DTV viewing terminal to the EPG server through the Internet; identifying the web requester in the EPG server; providing collected EPG in a webpage mode in the EPG server; and providing DTV presenting parameters from the EPG server to the browser-embedded DTV viewing terminal as soon as a desired program is selected.

### BACKGROUND OF THE INVENTION

1. Field of the Invention

The present invention relates to an electronic program guide (EPG) access apparatus and method, and more particularly to a browser-embedded digital television (DTV) viewing terminal, an EPG service system and method for exhibiting the EPG.

2. Description of the Related Art

DTV is becoming more and more popular throughout the world. In a DTV environment, the program guide is transmitted in a digital manner through a variety of channels. When a user turns on a DTV, the first thing he or she looks at is inevitably the EPG. Through the EPG, it is easier for the user to understand program content, and thus select the operations he or she needs, such as pre-recording, searching, scheduling and setting up personal preferences.

FIG. 1 depicts a prior art DTV broadcasting hint diagram. When a DTV content provider 11 has their content ready, they hand over the content to the DTV content broadcaster 12 to transmit to the end users. Sometimes the DTV content provider 11 and the DTV content broadcaster 12 are the same entity. The DTV content broadcaster 12 transmits the content through satellite, terrestrial or cable, and usually the EPG data is transmitted together with the content to the end user. In most situations, the DTV viewing terminal 13 receives the EPG data which is primarily composed of characters. Therefore it is predictable that the DTV viewing terminal 13 bears a heavy burden to receive, store, process and present the EPG data to end users. However, a large number of processing and calculations are not practical at the user end. In addition, because the EPG data broadcasted from the DTV content broadcaster 12 is the same for all the DTV viewing terminals 13, it is difficult to develop personalized or customized EPG services. Also, without the facilitation of audio and/or video information, the end users usually feel bored about the expression of pure characters.

U.S. Pat. No. 7,117,522 discloses an interactive EPG apparatus and method thereof. This prior art transmits multimedia data including text data and hypertext data associated with television broadcast programs. Although the prior art method is able to solve the interactivity issue, a lot of EPG data is transmitted to the user end, which wastes bandwidth and affects response time.

Because an interactive EPG is necessary to meet demands of a variety of users, it is important to design a cost effective apparatus and method to solve such an issue.

### SUMMARY OF THE INVENTION

The browser-embedded DTV viewing terminal in accordance with an embodiment of the present invention comprises a receiver, a browser and a hardware controller. The receiver is configured to receive web info from a remote EPG server through the Internet. The browser is operative to display the received web info and to select a desired program from the EPG server through the Internet. The hardware controller is configured to make an adjustment in receiving channel content according to DTV presenting parameters sent from the EPG server, while the DTV presenting parameters are sent from the EPG server as soon as the desired program is selected.

The EPG service system in accordance with an embodiment of the present invention comprises at least one browser-embedded DTV viewing terminal and an EPG server. The EPG server includes a receiver, a web server and a transmitter. The receiver is configured to receive a webpage-browsing request from a browser-embedded DTV viewing terminal through the Internet. The web server is configured to collect EPG data and exhibit in a webpage mode. The transmitter is configured to send DTV presenting parameters to the browser-embedded DTV viewing terminal as soon as a desired program is selected.

The method for exhibiting the EPG in accordance with an embodiment of the present invention comprises the steps of: sending a web request from a browser-embedded DTV viewing terminal to the EPG server through the Internet; identifying the web requester in the EPG server; providing collected EPG in a webpage mode in the EPG server; and providing DTV presenting parameters from the EPG server to the browser-embedded DTV viewing terminal as soon as a desired program is selected.

### BRIEF DESCRIPTION OF THE DRAWINGS

The invention will be described according to the appended drawings in which:

FIG. 1 shows a prior art EPG access diagram;

FIG. 2 shows a system structure in accordance with an embodiment of the present invention;

FIG. 3 depicts a hint diagram of the browser-embedded DTV viewing terminal in accordance with an embodiment of the present invention;

FIG. 4 shows a software structure of the browser-embedded DTV viewing terminal in accordance with an embodiment of the present invention; and

FIG. 5 depicts a hint diagram of the EPG server in accordance with an embodiment of the invention.

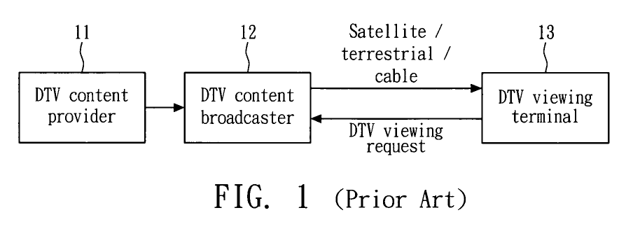

### PREFERRED EMBODIMENT OF THE PRESENT INVENTION

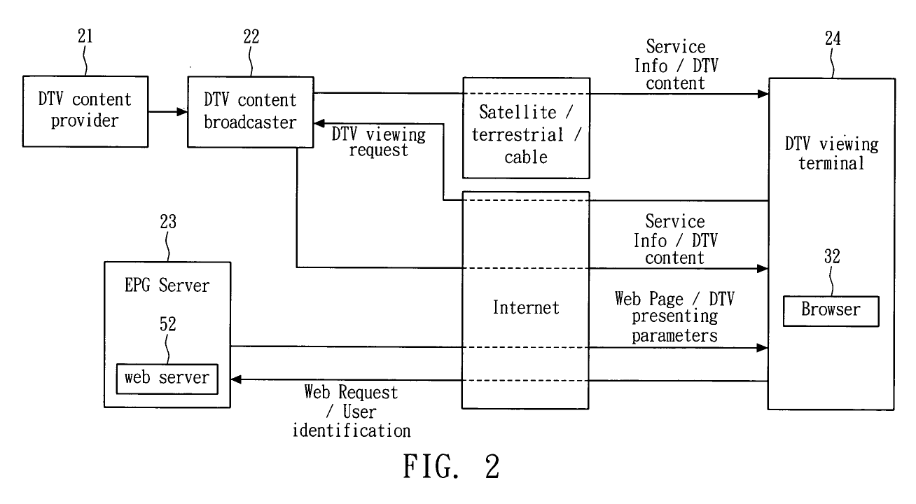

FIG. 2 shows a system structure according to an embodiment of the present invention. In addition to a DTV content provider 21 and a DTV content broadcaster 22, an EPG server 23 is provided for collecting and maintaining the EPG data rather than transmitting EPG data to the end users. The EPG server 23 includes a web server 52, which is configured to collect EPG data and exhibit in a webpage mode. A browser-embedded DTV viewing terminal 24 is able to connect to the EPG server 23 through the Internet. The browser-embedded DTV viewing terminal 24 includes a browser 32, which is operative to display the received web info and to select a desired program from the EPG server 23 through the Internet. The browser-embedded DTV viewing terminal 24 simply displays the screen of the EPG server 23, and neither calculation nor EPG data is made in the browser-embedded DTV viewing terminal 24. When the browser-embedded DTV viewing terminal 24 requests a web access, a network security mechanism of the EPG server 23 processes an action of user identification in order to verify the authorization level of the end user. For example, a first class client can access all of the channels, and a normal client can only access limited channels. In addition, the network security mechanism of the EPG server 23 can implement a public and/or private encryption to prevent hackers from invading the system. Because the EPG server 23 is implemented in a web-based access, through hyperlink technique, the interactive requirement can be met smoothly. Once the end user chooses one channel which he or she is interested in, the EPG server 23 will immediately transmit DTV presenting parameters, which are used to adjust a content-receiving device, to the browser-embedded DTV viewing terminal 24. If the content is received from a satellite, then the DTV presenting parameters include satellite tracks, satellite angle and bandwidth. If the content is received from the Internet, then the DTV presenting parameters include Internet Protocol (IP) address, linking and Uniform Resource Locator (URL). If the content is received from a terrestrial, then the DTV presenting parameters include frequency, bandwidth, modulation and program number.

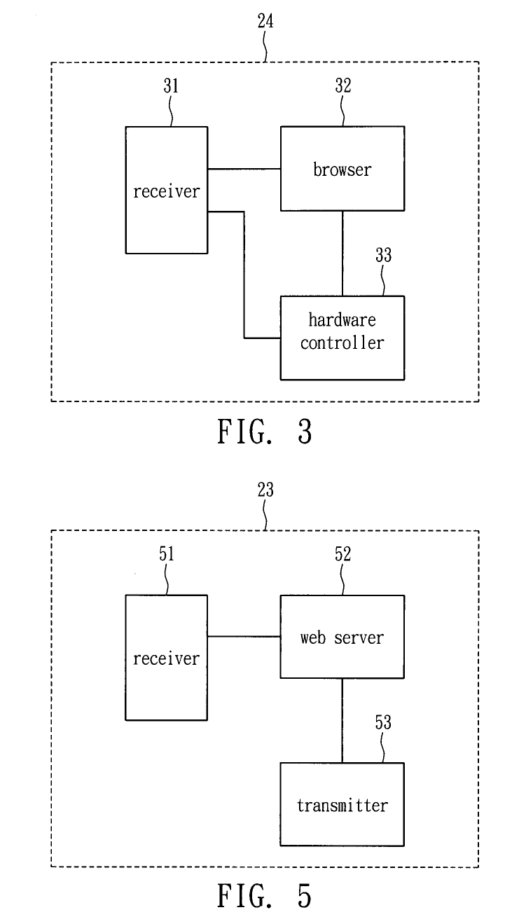

FIG. 3 depicts a hint diagram of the browser-embedded DTV viewing terminal 24 in accordance with an embodiment of the present invention. The browser-embedded DTV viewing terminal 24 includes a receiver 31, a browser 32 and a hardware controller 33. The receiver 31 is configured to receive web info from a remote EPG server 23 through the Internet. The web info includes webpage display and the DTV presenting parameters. The browser 32 is operative to display the received web info and to select a desired program from the EPG server 23 through the Internet. By means of the browser 32, the browser-embedded DTV viewing terminal 24 of the embodiment need not receive the EPG data as necessary in prior arts. The hardware controller 33 is configured to adjust a content-receiving device, such as a satellite signal receiver, according to the DTV presenting parameters sent from the EPG server 23, where the DTV presenting parameters are sent from the EPG server 23 to the browser-embedded DTV viewing terminal 24 as soon as the desired program is selected.

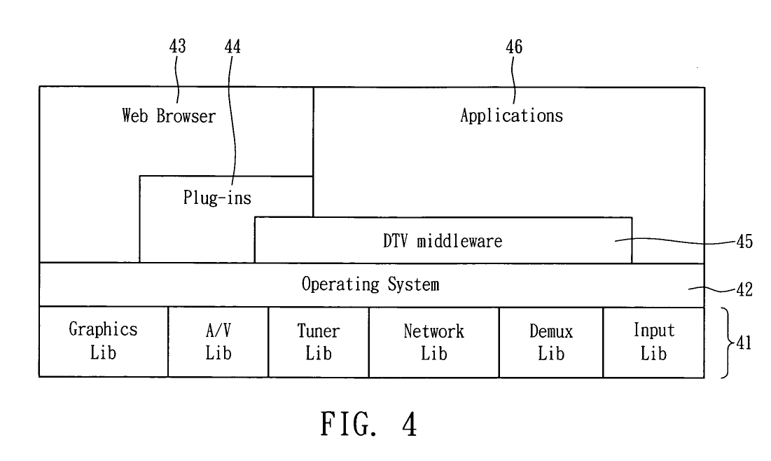

FIG. 4 shows a software structure of the browser-embedded DTV viewing terminal 24 in accordance with an embodiment of the present invention. The library group 41, such as graphics Lib, A/V Lib, tuner Lib, network Lib, demux Lib and input Lib, is used to control the content-receiving device in a correct direction or formality. The operating system 42 can adopt Linux or Windows simplified version. The web browser 43 can display the received web info and be used to select a desired program from the EPG server 23 through the Internet. The plug-ins 44 is add-on software, which is used to help the web browser 43 control the library group 41. The middleware 45, such as DVB-MHP (Digital Video Broadcast-Multimedia Home Platform), DCAP (Distributed Control Application Platform) or ARIB (Association of Radio Industries and Business), acts as a software platform or software interface, upon which an application program 46 is developed.

FIG. 5 depicts a hint diagram of the EPG server in accordance with an embodiment of the invention. The EPG server 23 includes a receiver 51, a web server 52 and a transmitter 53. The receiver 51 is configured to receive a webpage-browsing request from a browser-embedded DTV viewing terminal 24 through the Internet. The web server 52 is configured to collect EPG data and exhibit in a webpage mode. The transmitter 53 is configured to send the DTV presenting parameters to the browser-embedded DTV viewing terminal 24 as soon as a desired program is selected.

The EPG server in accordance with the embodiment of the present invention collects, processes and customizes EPG data. The EPG server of the embodiments, which has a more powerful computing capability and system resources (such as storages and network bandwidth) than the browser-embedded DTV viewing terminal does, makes elaborate EPG in webpage mode and provides customized EPG services together with security mechanism of network identification. By communication with the EPG server through the Internet, the browser-embedded DTV viewing terminal simply displays EPG on its screen in a webpage mode instead of downloading complete EPG data like prior arts do. Therefore, the present invention is able to save a lot of bandwidth and response time. Also, the goal of designing a customized EPG is achieved.

The above-described embodiments of the present invention are intended to be illustrative only. Numerous alternative embodiments may be devised by persons skilled in the art without departing from the scope of the following claims.

What is claimed is:

1. A browser-embedded digital television (DTV) viewing terminal, comprising:
a receiver configured to receive web info from a remote electronic program guide (EPG) server;
a browser operative to display the received web info and to select a desired program sent from the EPG server; and
a hardware controller configured to make an adjustment of the receiver according to DTV presenting parameters sent from the EPG server when the desired program is selected.

2. The browser-embedded DTV viewing terminal of claim 1, wherein the DTV presenting parameters comprise satellite tracks, satellite angle and bandwidth.

3. The browser-embedded DTV viewing terminal of claim 1, wherein the DTV presenting parameters comprise Internet Protocol (IP) address, linking and Uniform Resource Locator (URL).

4. The browser-embedded DTV viewing terminal of claim 1, wherein the DTV presenting parameters comprise frequency, bandwidth, modulation and program number.

5. The browser-embedded DTV viewing terminal of claim 1, wherein the browser comprises a plug-in, which receives the DTV presenting parameters, operative to control the hardware controller.

6. The browser-embedded DTV viewing terminal of claim 1, further comprising a library group, which is used to control the content-receiving device in a correct direction or formality.

7. The browser-embedded DTV viewing terminal of claim 1, further comprising middleware acting as a software platform.

8. An EPG service system, comprising:
at least one browser-embedded DTV viewing terminal; and
an EPG server, comprising:
a receiver configured to receive a webpage-browsing request from the browser-embedded DTV viewing terminal;
a web server configured to collect EPG data and exhibit in a webpage mode; and
a transmitter configured to send DTV presenting parameters to the browser-embedded DTV viewing terminal when a desired program is selected.

9. The EPG service system of claim 8, further comprising a network security mechanism, wherein the network security mechanism identifies the requester and/or verifies authorization level.

10. The EPG service system of claim 9, wherein the network security mechanism uses public and/or private encryption.

11. The EPG service system of claim 8, wherein the DTV presenting parameters comprise satellite tracks, satellite angle and bandwidth.

12. The EPG service system of claim 8, wherein the DTV presenting parameters comprise Internet Protocol (IP) address, linking and Uniform Resource Locator (URL).

13. The EPG service system of claim 8, wherein the DTV presenting parameters comprise frequency, bandwidth, modulation and program number.

14. A method for exhibiting EPG, comprising the steps of:
sending a web request from a browser-embedded DTV viewing terminal to the EPG server;
identifying the web requester in the EPG server;
providing collected EPG in a webpage mode in the EPG server; and
providing DTV presenting parameters from the EPG server to the browser-embedded DTV viewing terminal when a desired program is selected.

15. The method of claim 14, wherein the step of identifying the web requester determines whether or not the requester is authorized to access the EPG server.

16. The method of claim 14, further comprising the step of verifying the authorization level of the requester.

17. The method of claim 14, wherein the DTV presenting parameters comprise satellite tracks, satellite angle and bandwidth.

18. The method of claim 14, wherein the DTV presenting parameters comprise Internet Protocol (IP) address, linking and Uniform Resource Locator (URL).

19. The method of claim 14, wherein the DTV presenting parameters comprise frequency, bandwidth, modulation and program number.

20. The method of claim 14, wherein the EPG server does not transmit EPG data to the browser-embedded DTV viewing terminal.
